(19) United States
(12) Patent Application Publication
(10) Pub. No.: US 2013/0242858 A1
(43) Pub. Date: Sep. 19, 2013

(54) METHOD AND APPARATUS FOR WIDEBAND AND SUPER-WIDEBAND TELEPHONY

(71) Applicant: Gilbert A. Amine, Austin, TX (US)

(72) Inventor: Gilbert A. Amine, Austin, TX (US)

(73) Assignee: MICROSEMI SEMICONDUCTOR (U.S.) INC., Austin, TX (US)

(21) Appl. No.: 13/418,757

(22) Filed: Mar. 13, 2012

(51) Int. Cl. H04W 40/00; H04L 12/66; H04L 12/56

(52) U.S. Cl. 370/328; 370/401; 370/352

(57) ABSTRACT

A gateway includes at least one network interface, at least one analog telephony interface, and a processing unit operable to receive a bandwidth signal over the at least one analog telephony interface from a telephony device and configure an audio bandwidth of a telephony connection for the telephony device over the at least one network interface based on the bandwidth signal.

### CROSS-REFERENCE TO RELATED APPLICATIONS

Not applicable.

### BACKGROUND

The disclosed subject matter relates generally to wideband telephony and, more particularly, to a method and apparatus for wideband and super-wideband telephony.

Analog telephones have evolved since their inception in the late 1800's and offer enhanced capabilities such as DTMF dialing, speed dialing, speakerphone, Caller ID, etc. However, the audio range that is supported by such telephones has remained limited to about 3.4 kHz, the bandwidth of the traditional public switched telephone network (PSTN). The PSTN was originally designed as an analog circuit-switched network and the frequency band that was available to the subscriber's voice calls was set from 300 Hz to 3.4 kHz.

The PSTN has evolved over the years and is now almost entirely digital in its core. However, the basic plain old telephone service (POTS) has remained analog with an audio bandwidth of about 3.4 kHz, even on short loops that are capable of carrying very high frequencies such as those used by DSL modems. The main reason and benefit for making this limitation is compatibility. New and old analog telephones alike can operate on POTS service offered by modern digital central offices as well as older systems, such as electromechanical ones, that may still be used in some rural areas. Today, there are over one billion analog telephones in use around the world for POTS service.

The rapid growth of broadband technology has given rise to voice over Internet Protocol (VoIP) services, which use an IP network such as the Internet for placing and transporting the calls. In the early days of VoIP, customers bought an Analog Telephone Adapter (ATA) and connected their home analog telephones to it. The ATA provides an analog telephone line with similar electrical characteristics and signaling as a PSTN line and performs the conversion between the analog signals from the connected telephone and the VoIP servers. Standalone ATAs are giving way to more integrated “gateways” that offer additional functions such as a broadband modem or a wired and/or wireless router. One example gateway is a Motorola Netopia 2247-42, which combines an ADSL2+ modem with a 4-port Ethernet switch and router, a WiFi router, and two analog telephone voice ports, also known as FXS (or Foreign eXchange Station), for VoIP calling.

VoIP ATAs and gateways feature FXS circuits which can offer the same signaling characteristics found on the POTS service from a PSTN. This includes limiting the audio channel to 3.4 kHz (or Narrowband). Newer FXS circuits, such as those based on the Microsemi VE8910 series, can also support wideband (WB) telephony with a 7 kHz bandwidth. Future FXS chipsets can expand the audio bandwidth to 12 kHz or more, effectively making them super-wideband (SWB) capable. Various studies have shown that expanding the bandwidth of telephone calls can enhance the voice quality and allow subscribers to distinguish confusing sounds, better understand accented speakers, decipher words that have close sounds such as ‘s’ and ‘f’, and reduce listening fatigue. These benefits improve the customer experience and can result in increased use of the telephone service. Higher audio bandwidth will also make speech recognition more accurate in interactive voice response systems.

Many ATAs and gateways feature FXS chipsets and circuitry that can readily support wideband telephony as a software option with no hardware modifications. VoIP standards and many service providers support 7 kHz wideband audio based on coder-decoders (CODECS) such as G.722 and will soon support super-wideband CODECS such as G.722.1 Annex C (or G.722.1C) for 14 kHz telephony. However, since VoIP ATAs and gateways are designed for compatibility with the large installed base of narrowband (NB) analog telephones and due to compatibility issues, the FXS ports on such devices are usually configured for narrowband-only operation. Connecting narrowband telephones or modems and fax machines to wideband FXS ports can cause compatibility issues. For example, narrowband telephones can “hear” wideband noise if no real wideband audio content is present. Modems and fax machines can have degraded performance when connected to wideband FXS ports. Another problem is that the ATA or gateway does not readily know if an analog telephone connected to it is wideband capable. Reserving higher bandwidth on the VoIP link at all times when only a small fraction of telephones may actually be wideband capable is not economical.

For these reasons, the FXS ports on VoIPs ATA and gateways are normally set to narrowband. Telephone equipment manufacturers have shied away from making wideband analog telephones since they could not be used on the PSTN and since VoIP ATA and gateways do not currently support wideband. Wideband VoIP service today is limited to IP Phones and PC-based soft clients. Users of such services have enjoyed the increased voice quality and some VoIP service providers have recently started offering super-wideband service for even greater clarity.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a gateway that includes at least one network interface, at least one analog telephony interface, and a processing unit operable to receive a bandwidth signal over the at least one analog telephony interface from a telephony device and configure an audio bandwidth of a telephony connection for the telephony device over the at least one network interface based on the bandwidth signal.

Another aspect of the disclosed subject matter is seen in a telephony device that includes a speaker, an interface for coupling to an analog telephone line, a signal detector operable to receive a bandwidth alert signal over the interface, a signal generator operable to send a bandwidth acknowledgement signal over the interface indicating a bandwidth capability of the telephony device, and a processor operable to receive an analog voice signal over the interface having an audio bandwidth corresponding to the bandwidth capability and transmit the analog voice signal to the speaker.

Yet another aspect of the present subject matter is seen in a method for configuring a telephony device. The method includes receiving a bandwidth alert signal, generating a bandwidth acknowledgement signal indicating a bandwidth capability of the telephony device, receiving an analog voice signal having an audio bandwidth corresponding to the bandwidth capability, and transmitting the analog voice signal to a speaker of the telephony device.

One of a plurality of filters may be selected for use by the telephony device based on the bandwidth capability. Each of the plurality of filters has a different bandwidth.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified block diagram of a gateway for providing telephony services and negotiating call bandwidth in accordance with an illustrative embodiment of the present subject matter;

FIG. 2 is a diagram of an exemplary software architecture employed by the gateway of FIG. 1;

FIG. 3 is a diagram illustrating typical bandwidth ranges associated with narrowband, wideband, and super-wideband telephony services;

FIG. 4 is a simplified block diagram of an exemplary wideband telephony device;

FIG. 5 is a simplified block diagram of an exemplary wideband cordless telephone base station telephony device;

FIG. 6 is a flow diagram illustrating the operation of the gateway of FIG. 1 for detecting the bandwidth capabilities of the interfacing telephony device for an outgoing call sequence;

FIG. 7 is a flow diagram illustrating the operation of the gateway of FIG. 1 for detecting the bandwidth capabilities of the interfacing telephony device for an incoming call sequence;

FIG. 8 is a flow diagram illustrating the operation of a telephony device for communicating its bandwidth capabilities to the gateway of FIG. 1 for an incoming or outgoing call sequence;

FIG. 9 is a diagram of an exemplary bass boost equalization profile that may be employed by the gateway of FIG. 1; and

FIG. 10 is a diagram of exemplary high frequency equalization profiles for different bandwidths and line lengths that may be employed based on measurements of received levels of test tones by the gateway of FIG. 1.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

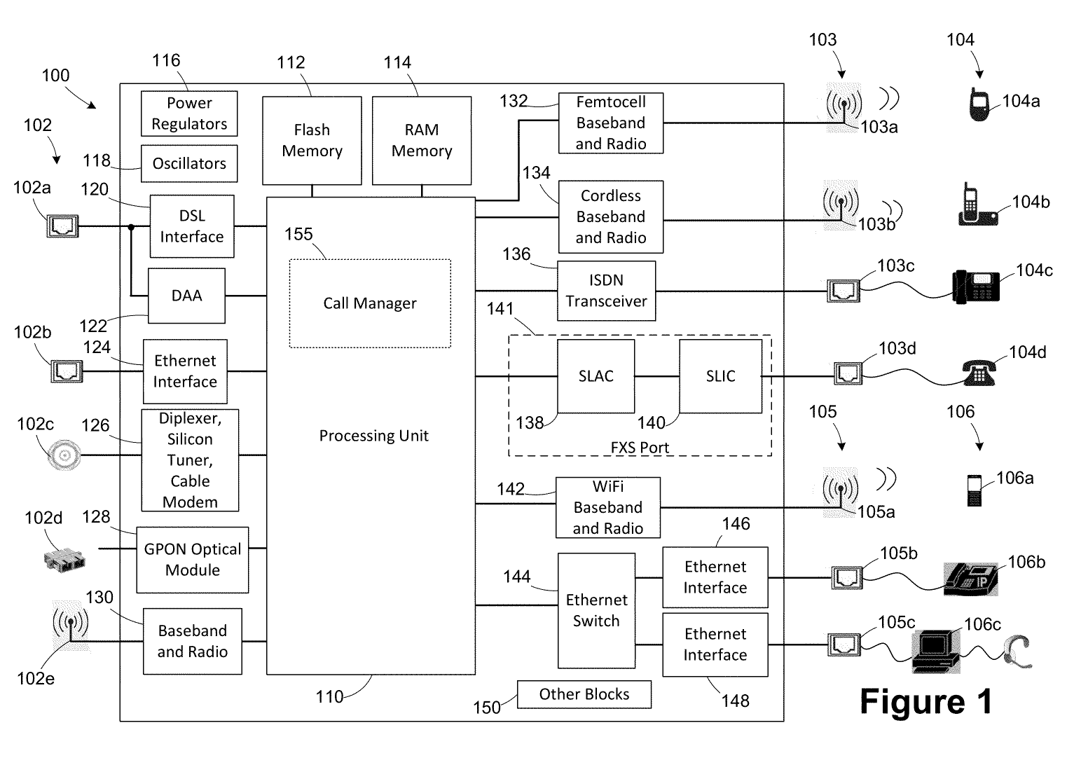

Referring now to the drawings wherein like reference numbers correspond to similar components throughout the several views and, specifically, referring to FIG. 1, the disclosed subject matter shall be described in the context of a gateway 100. The gateway 100 includes a one or more network interfaces 102 (e.g., wide area network interfaces) for communicating with an IP network and one or more analog telephony interfaces 103 for communicating with telephony devices 104. The gateway 100 may also include one or more local network interfaces 105 (local area network interfaces) that may provide local data access or telephony access through IP telephony devices 106. Exemplary network interfaces 102 include an RJ-11 port 102a (e.g., a DSL and/or PSTN), an RJ-45 port 102b (e.g., Ethernet WAN port), a coaxial cable port 102c, an optical fiber port 102d, and a mobile station antenna 102e (e.g., a 3G or 4G antenna).

Exemplary analog telephony interfaces 103 include a femtocell antenna 103a (e.g., short range cellular antenna) for interfacing with a mobile telephone 104a, a cordless base station antenna 103b for interfacing with a cordless telephone 104b, an RJ-45 ISDN port 103c for interfacing with an ISDN telephone 104c, or an RJ-11 port 103d for interfacing with an analog telephone 104d. Exemplary local network interfaces 105 include a WiFi antenna 105a (e.g., 802.11x) for interfacing with a WiFi telephone 106a, an RJ-45 port 105b (e.g., Ethernet LAN port) for interfacing with an IP telephone 106b, an RJ-45 port 105c for interfacing with a personal computer 106c (i.e., equipped with headset or a microphone and speakers).

The particular number and type of network interfaces 102, analog telephony interfaces 103, telephony devices 104, local network interfaces 105, and/or IP telephony devices 106 may vary depending on the particular implementation. Interface types other than those illustrated in FIG. 1 may be employed. Also, not all of the interface types may be present in an actual implementation. For example, if the provider for the gateway 100 is a cable operator, it may only have the coaxial cable port 102c as its network interface 102. The gateway 100 may provide both telephony services through a telephony connection and parallel network services through a data connection. For example, the WiFi antenna 105a and/or the RJ-45 ports 105b, 105c may provide general network connectivity. The gateway 100 may thus serve as a router, access point, etc. The particular analog telephony interface 103 used to connect to a telephony device 104 may differ from the interface 105 used to provide general network connectivity.

The gateway 100 includes a processing unit 110 (e.g., a microprocessor, system-on-chip (SoC), digital signal processor, or combinations thereof), non-volatile memory 112 (e.g., flash) and/or volatile memory 114 (e.g., synchronous or dynamic random access memory). One or more power regulators 116 may be provided for generating power supplies at various voltages for the components of the gateway 100, and one or more oscillators 118 may be provided for generating clock or synchronization signals for the components.

The gateway 100 includes physical layer (PHY) and/or media access control (MAC) hardware for supporting communication over the various network interfaces 102 and analog telephony interfaces 103. In general, hardware and/or software for supporting these functions is known to those of ordinary skill in the art, and they are not described in greater detail herein for sake of clarity and to avoid obscuring the present subject matter.

A DSL interface 120 (e.g., analog front end and modem) and digital access arrangement (DAA) 122 interface through the RJ-11 port 102a to establish DSL connectivity and PSTN voice service. An Ethernet interface 124 (e.g., Ethernet physical layer (PHY) and transformer) interfaces though the RJ-45 port 102b. A diplexer, silicon tuner, and cable modem unit 126 interfaces via the coaxial cable port 102c. A gigabit passive optical network (GPON) optical module 128 interfaces through the optical fiber port 102d. A baseband and radio unit 130 provides a wireless network connection via the mobile station antenna 102e.

A femtocell baseband and radio unit 132 provides an interface using the femtocell antenna 103a. A cordless baseband and radio unit 134 provides an interface using the cordless base station antenna 103b. An ISDN transceiver 136 provides an interface via the RJ-45 port 103c. A subscriber line audio circuit (SLAC) 138 and subscriber line interface circuit (SLIC) 140 combine to provide a foreign exchange service (FXS) port 141 to interface with the RJ-11 port 103d.

A WiFi baseband and radio unit 142 provides an interface via the WiFi antenna 105a. An Ethernet switch 144 and Ethernet interfaces 146, 148 (e.g., Ethernet physical layer (PHY) and transformer) provide interfaces via the RJ-45 ports 105b, 105c. The gateway 100 may also have one or more other units 150 to provide functions not within the scope of this description. Also, although certain units are illustrated as being distinct, it is contemplated that one or more of them may be integrated into the processing unit 110. For example, the cordless baseband processing functionality, the power regulation functionality, and/or the SLAC functionality may be integrated into the processing unit 110.

As will be described in greater detail below, one or more of the telephony devices 104 may support extended bandwidth audio services, commonly referred to as wideband or super-wideband. The gateway 100 is adapted to identify the capabilities of the telephony device 104 and communicate those capabilities with a far-end telephony device and to enhance the actual or perceived audio quality to the telephony device 104. The availability of extended audio bandwidth may depend on the particular telephony device 104 used to place or answer a particular call and on the far-end telephony device. The gateway 100 may support multiple simultaneous devices, so the audio bandwidth may vary between devices. The gateway 100 implements a call manager 152 to negotiate at call time the highest level of telephony audio bandwidth.

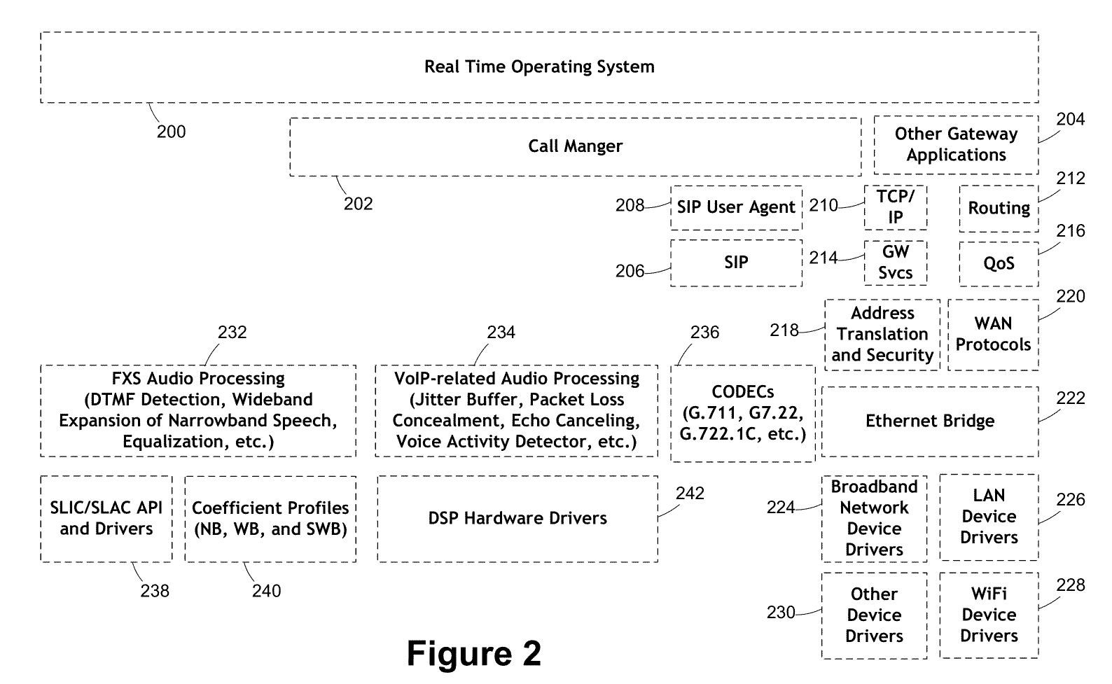

Turning now to FIG. 2, a diagram illustrating the software architecture of the gateway 100 is provided. The gateway 100 runs under the control of an operating system 200. Higher level software includes a call manager module 202 (i.e., corresponding to the call manager 152 of FIG. 1) for controlling the telephony services. Other gateway applications 204 may also be provided. For example, applications related to non-telephony network services may be provided. A session initiated protocol (SIP) module 206 and SIP user agent 208 are provided for negotiating the parameters of voice-over-IP (VoIP) calls. Typically, the SIP protocol is an application layer that is independent of the transport protocol. The transport protocol is handled by a TCP/IP module 210, a routing module 212, a gateway services module 214, a quality of service (QoS) module 216, an address translation and security module 218, and a WAN protocol module 220. An Ethernet bridge 222 is provided for communicating over Ethernet networks. Network communication support is provided for the physical layer interface units depicted in FIG. 1 by broadband network device drivers 224, LAN device drivers 226, WiFi device drivers 228, and other device drivers 230. Telephony support is provided via a foreign exchanges service (FXS) module 232 that provides functionality for dual tone multi-frequency (DTMF) detection, wideband expansion of narrowband speech (WENS), equalization, etc., a VOIP audio processing module 234 that provides functionality for jitter buffering, packet loss concealment, echo canceling, voice activity detection, etc., a CODEC module 236, a SLIC/SLAC application programming interface (API) and driver module 238, a coefficient profile module 240 including coefficients for narrowband, wideband, and super-wideband communication, and a DSP hardware driver module 242. The design and operation of software modules suitable for implementing the functionality of the gateway 100 are known to those of ordinary skill in the art, and they are not described in greater detail herein.

It is contemplated that some of the functionality described in FIG. 2 as being associated with the processing unit 110, may be integrated into the SLAC 138. For example, the call manager module 202 functionality or portions of the FXS module 232 functionality may be provided by the SLAC 138. Also, various functions associated with the SLAC 138 may be provided by the processing unit 110.

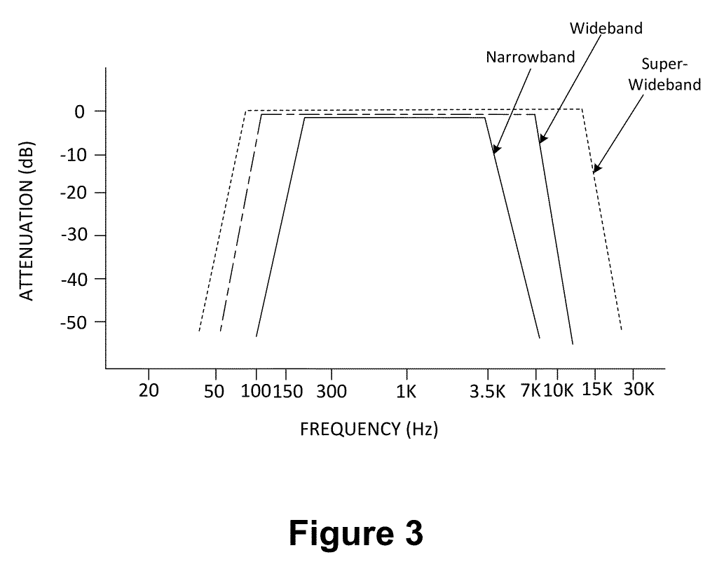

Conventional analog FXS ports and telephone devices support narrowband signals, as illustrated in FIG. 3 on a logarithmic scale. Wideband and super-wideband telephony devices use a wider audio frequency spectrum to provide an improved user experience. In the illustrated embodiment, the gateway 100 provides the highest bandwidth supported by the telephony device 104. As will be described in greater detail below, the call manager 152 in the gateway 100 signals the telephony device to determine which bandwidth is supported. The gateway 100 sends a bandwidth alert signal to the telephony device 104, and the telephony device 104 responds with a bandwidth signal and then negotiates with the far-end telephone's gateway based on the determined capabilities. In the event the far-end station only supports a lower bandwidth than the local telephony device 104 is capable of receiving, the gateway 100 extends the audio bandwidth of the audio from the far-end before transmitting it to the telephony device 104. In that case, the gateway 100 also filters out the wideband or super-wideband frequencies from the telephony device 104 before transmitting them to the far-end station.

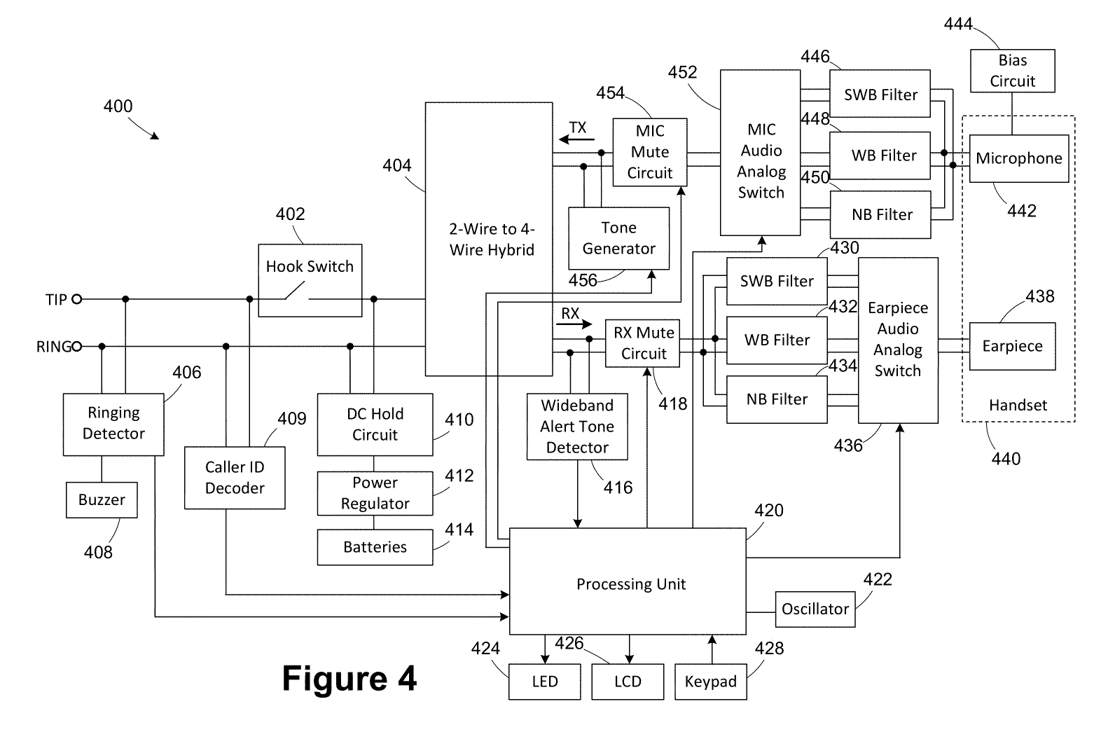

FIG. 4 is a simplified block diagram of an exemplary telephony device 400. In the illustrated embodiment, the telephony device 400 is a wideband telephone, such as the telephony device 104g. The telephony device 400 interfaces with conventional tip and ring lines using a hook switch 402 and a 2-wire to 4-wire hybrid circuit 404. A ringing detector 406 detects a ringing signal on the tip and ring lines and controls a buzzer 408 to inform a user of an incoming call. A caller ID decoder 409 detects caller ID data on the telephone line (tip and ring wires). A DC hold circuit 410 provides the DC loop characteristics necessary to interface over the telephone line and feeds power to a regulator 412. An optional battery 414 provides power when the telephone is on-hook and not powered from the line.

The hybrid 404 converts the 2-wire Tip/Ring telephony signals to separate Receive (RX) and Transmit (TX) paths. The receive path includes a tone detector 416 for identifying wideband alert tones (WBAT), also referred to as a bandwidth alert tone or bandwidth alert signal. A receiver mute circuit 418 is provided for muting the receive path to prevent signaling tones from being heard by a user. A processing unit 420 (e.g., microcontroller, DSP, or a combination thereof) is provided to implement the functionality of the telephony device 400. The processing unit 420 interfaces with one or more of a light emitting diode (LED) 424, a liquid crystal display (LCD) 426, and a keypad 428 to provide a user interface for operating the telephony device 400. An oscillator 422 provides a clock signal for the processing unit 420. The receive signal is provided to a super-wideband filter 430, a wideband filter 432, or a narrowband filter 434. Depending on the type of session established for the telephony device 400, an earpiece audio analog switch 436 selects the output from of the filters 430, 432, 434 and provides the output to an earpiece 438 in a handset 440 of the device 400 or some other speaker of the device 400 (e.g., for a speakerphone).

Transmit audio signals in the telephony device 400 are generated through a microphone 442 in the handset 440. A bias circuit 444 powers the microphone 442. Transmit filters 446, 448, 450 are provided according to the bandwidth selected, super-wideband, wideband, or narrowband, respectively, and the output of one of the filters 446, 448, 450 is selected by a microphone audio analog switch 452. A microphone mute circuit 454 is provided for selectively muting the microphone 442. A tone generator 456 is provided for generating dialing DTMF tones or wideband acknowledge (ACK) tones, also referred to as a bandwidth signal or a bandwidth acknowledgement signal. Although illustrated as separate units, it is contemplated that one or more of the units, such as the caller ID decoder 409, the tone detector 416, and/or the tone generator 456, may be integrated into the processing unit 420.

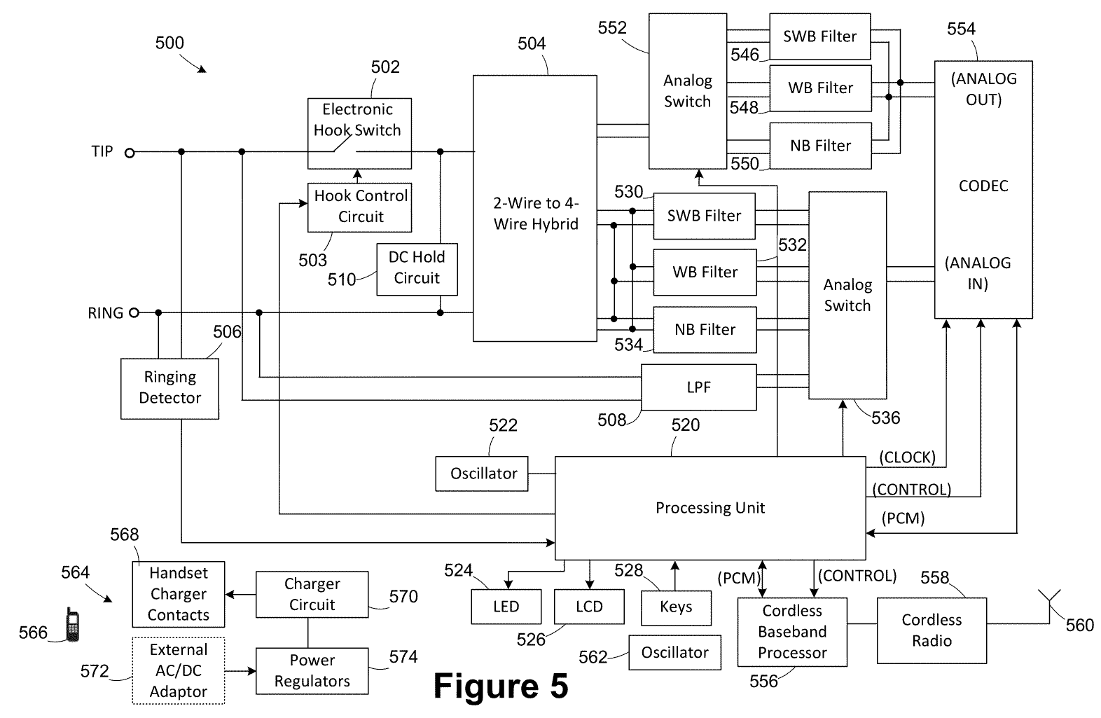

FIG. 5 is a simplified block diagram of another embodiment of a telephony device 500. In the illustrated embodiment, the telephony device 500 is a wideband cordless telephone base station. As shown in FIG. 1, the wideband cordless telephone base station may be integrated into the gateway 100 using the cordless baseband and radio unit 134, the antenna 103b, and the cordless handset 104b. The telephony device 500 interfaces with conventional tip and ring lines using an electronic hook switch 502 controlled by an associated hook control circuit 503 and a 2-wire to 4-wire hybrid circuit 504. A ringing detector 506 detects a ringing signal on the tip and ring lines. A narrowband filter 508 is used in detecting caller ID data on the tip and ring lines. A DC hold circuit 510 provides the DC loop characteristics necessary to interface over the tip and ring lines.

The hybrid 504 provides a transmit path and a receive path. A processing unit 520 (e.g., microcontroller, DSP, or a combination thereof) is provided to provide the functionality of the telephony device 500. An oscillator 522 provides a clock signal for the processing unit 520. The processing unit 520 performs functions such as muting and tone processing (e.g., detection or generation) for identifying or generating dialing tones (i.e., DTMF tones) and wideband signaling tones (WBAT and ACK). The processing unit 520 interfaces with one or more of a light emitting diode (LED) 524, a liquid crystal display (LCD) 526, and one or more keys 528. The receive signal is provided to a super-wideband filter 530, a wideband filter 532, or a narrowband filter 534. Depending on the type of session established for the telephony device 500, an analog switch 536 selects the output from of the filters 530, 532, 534. Transmit signals for the telephony device 500 are provided to transmit filters 546, 548, 550 according to the bandwidth selected, and the output of one of the filters 546, 548, 550 is selected by an analog switch 552.

Processing of the analog transmit and receive signals is performed by a CODEC 554 that interfaces with the processing unit 520. In the illustrated embodiment, the sampling rate of the CODEC 554 is controlled by the processing unit 520 and is adjusted to correspond to the desired bandwidth. For example, the CODEC 554 will typically sample audio at the rate of 8,000 samples per second for Narrowband, 16,000 samples per second for Wideband, and 32,000 samples per second for Super-Wideband. The processing unit 520 communicates voice and control signals to a cordless baseband processor 556. The baseband processor 556 controls a cordless radio 558, which in turn, generates cordless radio signals through an antenna 560. Oscillator 562 provides one or more clocks to the cordless baseband processor 556.

A docking station 564 may be provided for receiving a cordless handset 566. The docking station 564 includes charging contacts 568. A charger circuit 570 monitors the charging state of the cordless handset 566 and provides a charging current at the handset charging contacts 568 as necessary. An external AC/DC adaptor 572 powers the various blocks of the telephone device through one or more power regulators 574. Although illustrated as separate units, it is contemplated that one or more of the units, such as the CODEC 554, the cordless baseband processor 556, one or more power regulators 574, and/or the charger circuit 570, may be integrated into the processing unit 520. In the illustrated embodiment, the air interface and audio CODEC used for communication between the cordless radio 558 and the cordless handset 566 are configured to support Wideband or Super-Wideband to take advantage of the expanded bandwidth capability.

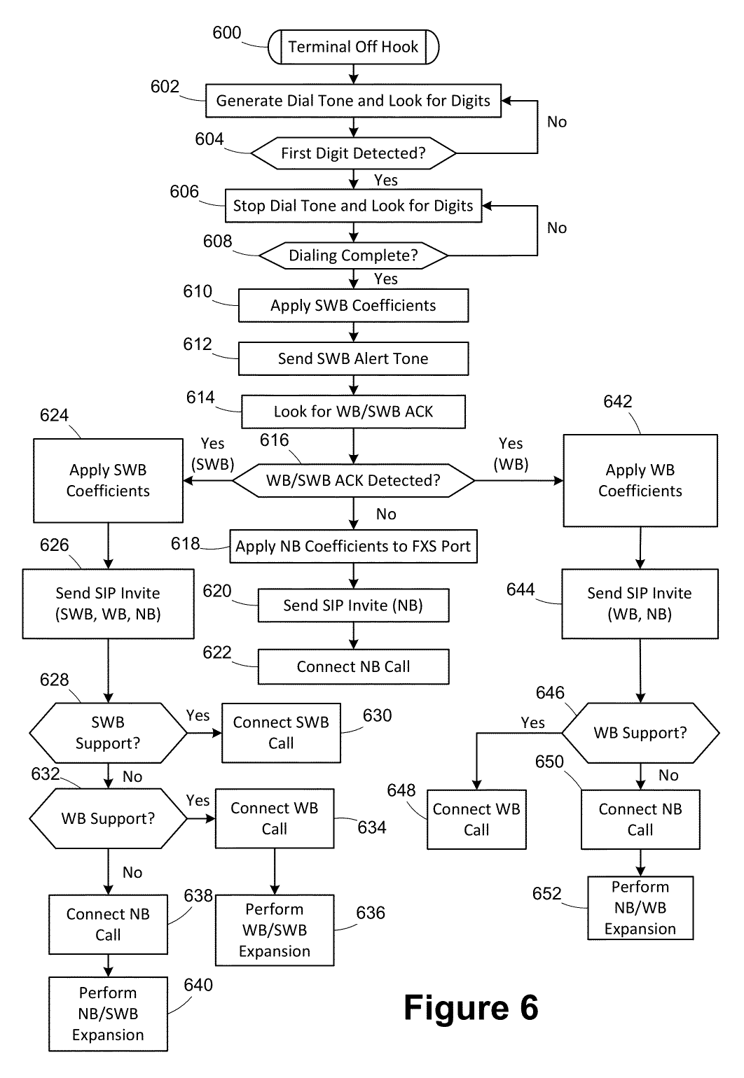

FIG. 6 is a flow diagram illustrating the operation of the gateway 100 for detecting the bandwidth capabilities of the interfacing telephony device 104 for an outgoing call sequence. In some cases, the far-end station/VoIP connection to which the telephony device 104 connects supports a lower audio bandwidth than the telephony device 104. In one embodiment, rather than delivering the lower bandwidth audio to the telephony device 104, the gateway 100 performs bandwidth expansion on the received signal from the far-end station prior to transmitting it to the telephony device 104 to estimate the frequency components that would have been present had the far end-station supported a higher bandwidth audio. This expansion is commonly referred to as wideband expansion of narrowband speech (WENS). Techniques for performing bandwidth expansion of acoustic signals are known to those of ordinary skill in the art, so they are not described in greater detail herein. In general, the bandwidth expansion improves the quality of the signal perceived by the local user of the telephony device 104, but has no impact on the quality perceived by the user of the far-end station. The quality improvement is not as high as what would be achieved if both stations had supported the higher audio bandwidth connection, but better than what would be realized by restricting the telephony device 104 to a lower bandwidth audio connection. The far-end user does not perceive any improvement in the audio quality as the WENS is applied only to the audio going to the local telephony device 104.

In the illustrated embodiment, the gateway 100 may employ NB/SWB expansion (e.g., expand received NB audio [300 Hz-3.4 KHz] to SWB audio [50 Hz to 12 KHz]), NB/WB expansion (e.g., expand received NB audio [300 Hz-3.4 KHz] to WB audio [50 Hz to 7 KHz]), or WB/SWB expansion (e.g., expand received WB audio [50 Hz-7 KHz] to SWB audio [50 Hz to 12 KHz]). In the illustrated embodiment, the WENS capability is provided by the FXS module 232 shown in FIG. 2.

When using audio bandwidth expansion, the gateway 100 also filters out the enhanced bandwidth audio from the telephony device 104 before encoding and transmitting it to the far-end station. When using NB/SWB expansion, the gateway 100 filters out the SWB audio [50 Hz-300 Hz and 3.4 KHz to 12 KHz] prior to transmitting audio to the far end station. When using NB/WB expansion, the gateway 100 filters out the WB audio [50 Hz-300 Hz and 3.4 KHz to 7 KHz]. When using WB/SWB expansion, the gateway 100 filters out the SWB audio [7 KHz to 12 KHz]. In the illustrated embodiment, the transmit filtering capability is provided by the FXS module 232 shown in FIG. 2.

In method block 600, the terminal goes off-hook (e.g., the hook switch 402 in FIG. 4 or the hook switch 502 in FIG. 5 is opened and detected by the gateway 100), indicating a user is initiating a call. In method block 602, the gateway 100 generates a dial tone (e.g., via the SLAC 138 and SLIC 140 in FIG. 1). The gateway 100 loops between method blocks 604 and 602 until the first digit is detected in method block 604. After detecting the first digit, the dial tone is terminated and the gateway 100 looks for additional digits. The gateway 100 determines if dialing is complete in method block 608 (e.g., based on an elapsed time interval or based on the detection of a predetermined number of digits) and loops back to method block 606 until dialing completion is detected.

After dialing is complete in method block 608, the gateway 100 applies SWB coefficients (provided by the coefficient profile module 240 in FIG. 2) for the FXS port 141 in method block 610. In method block 612, the gateway 100 sends a SWB alert tone, and waits for an acknowledgement (ACK) in method block 614. In method block 616, the gateway 100 determines if a SWB acknowledgement, a WB acknowledgement, or no acknowledgement has been detected.

If no acknowledgement has been detected in method block 616, indicating that the telephony device 104 supports only NB connections, the gateway 100 applies NB coefficients (provided by the coefficient profile module 240 in FIG. 2) for the FXS port 141 in method block 618, sends a SIP Invite indicating that only NB (e.g., G.711 CODEC) is supported to the far-end station in method block 620, and connects the NB call in method block 622 using the G.711 CODEC provided in the CODEC module 236 in FIG. 2. As used herein, the term far-end station is intended to cover a telephony device and/or a gateway for servicing the telephony device.

If a SWB acknowledgement has been detected in method block 616, indicating that the telephony device 104 supports SWB connections, the gateway 100 applies SWB coefficients (provided by the coefficient profile module 240 in FIG. 2) for the FXS port 141 in method block 624 and sends a SIP Invite indicating that SWB, WB, and NB are supported far-end station in method block 626. Based on the SIP response of the far-end station, the local gateway 100 determines what bandwidth is supported. If the SIP response indicates SWB support in method block 628, the gateway 100 connects the SWB call in method block 630 using the G.722.1c CODEC provided in the CODEC module 236 in FIG. 2. If the SIP response indicates WB support in method block 632, the gateway connects the WB call in method block 634 using the G.722 CODEC provided in the CODEC module 236 in FIG. 2. In method block 636, the gateway 100 performs a WB/SWB expansion of the far-end audio prior to transmission to the telephony device 104 and a filtering of the audio from the telephony device 104 prior to transmission to the far-end station.

If the SIP response indicates only NB support in method block 632, the gateway connects the NB call in method block 638 using the G.711 CODEC provided in the CODEC module 236 in FIG. 2. In method block 640, the gateway 100 performs a NB/SWB expansion of the far-end audio prior to transmission to the telephony device 104 and a filtering of the audio from the telephony device 104 prior to transmission to the far-end station.

If a WB acknowledgement (ACK) has been detected in method block 616, indicating that the telephony device 104 supports WB connections, the gateway 100 applies WB coefficients (provided by the coefficient profile module 240 in FIG. 2) to the FXS port 141 in method block 642 and sends a SIP Invite indicating that WB and NB are supported to the far-end station in method block 644. Based on the SIP response of the far-end station, the gateway 100 determines what bandwidth is supported. If the SIP response indicates WB support in method block 646, the gateway connects the WB call in method block 648 using the G.722 CODEC provided in the CODEC module 236 in FIG. 2. If the SIP response indicates NB support in method block 646, the gateway connects the NB call in method block 650 using the G.722 CODEC provided in the CODEC module 236 in FIG. 2. In method block 652, the gateway 100 performs a NB/WB expansion of the far-end audio prior to transmission to the telephony device 104 and a filtering of the audio from the telephony device 104 prior to transmission to the far-end station.

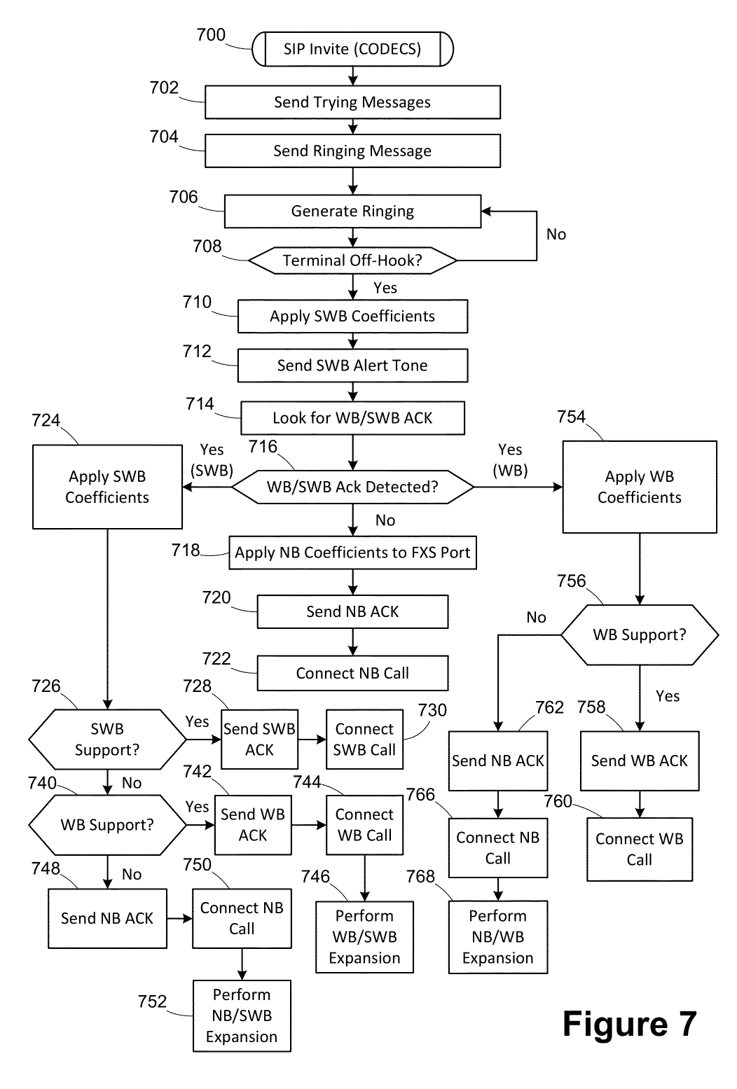

FIG. 7 is a flow diagram illustrating the operation of the gateway 100 for detecting the bandwidth capabilities of the interfacing telephony device 104 for an incoming call sequence. In method block 700, a SIP Invite is received from a far-end station. The SIP Invite includes the CODEC supported by the far-end station. In method block 702, the gateway 100 sends a “Trying” message to the far-end station. In method block 704, the gateway sends a “Ringing” message to the far end station and generates a ringing signal to the connected telephony device 104 in method block 706. In method blocks 706 and 708, the gateway 100 monitors for an off-hook state of the telephony device 104. Once, the off-hook state is identified in method block 708, the gateway 100 stops ringing and applies SWB coefficients (provided by the coefficient profile module 240 in FIG. 2) for the FXS port 141 in method block 710. In method block 712, the gateway 100 sends an SWB alert tone and waits for an acknowledgement (ACK) in method block 714. In method block 716, the gateway 100 determines if a SWB acknowledgement, a WB acknowledgement, or no acknowledgement has been detected.

If no acknowledgement has been detected in method block 716, indicating that the telephony device 104 supports only NB audio, the gateway 100 applies NB coefficients (provided by the coefficient profile module 240 in FIG. 2) for the FXS port 141 in method block 718, sends a SIP Acknowledgement indicating that only NB (e.g., G.711 CODEC) is supported to the far-end station in method block 720, and connects the NB call in method block 722 using the G.711 CODEC provided in the CODEC module 236 in FIG. 2.

If a SWB acknowledgement has been detected in method block 716, indicating that the telephony device 104 supports SWB audio, the gateway 100 applies SWB coefficients (provided by the coefficient profile module 240 in FIG. 2) for the FXS port 141 in method block 724. If the SIP Invite indicates SWB support by the far-end station in method block 726, the gateway 100 sends a SIP Acknowledgement indicating that SWB is supported to the far-end station in method block 728 and connects the SWB call in method block 730 using the G.722.1c CODEC provided in the CODEC module 236 in FIG. 2. If the SIP Invite indicates WB support for the far-end station in method block 740, the gateway sends a SIP Acknowledgement indicating that WB is supported in method block 742 and connects the WB call in method block 744 using the G.722 CODEC provided in the CODEC module 236 in FIG. 2. In method block 746, the gateway 100 performs a WB/SWB expansion of the far-end audio prior to transmission to the telephony device 104 and a filtering of the audio from the telephony device 104 prior to transmission to the far-end station.

If the SIP Invite indicates only NB support in method block 748, the gateway connects the NB call in method block 750 using the G.711 CODEC provided in the CODEC module 236 in FIG. 2. In method block 752, the gateway 100 performs a NB/SWB expansion of the far-end audio prior to transmission to the telephony device 104 and a filtering of the audio from the telephony device 104 prior to transmission to the far-end station.

If a WB acknowledgement has been detected in method block 716, indicating that the telephony device 104 supports WB audio, the gateway 100 applies WB coefficients (provided by the coefficient profile module 240 in FIG. 2) for the FXS port 141 in method block 754. If the SIP Invite indicated WB support by the far-end station in method block 756, the gateway 100 sends a SIP Acknowledgement indicating that WB is supported to the far-end station in method block 758 and connects the WB call in method block 760 using the G.722 CODEC provided in the CODEC module 236 in FIG. 2. If the SIP Invite indicates only NB support for the far-end station in method block 756, the gateway sends a SIP Acknowledgement indicating that NB is supported in method block 762 and connects the NB call in method block 766 using the G.711 CODEC provided in the CODEC module 236 in FIG. 2. In method block 768, the gateway 100 performs a NB/WB expansion of the far-end audio prior to transmission to the telephony device 104 and a filtering of the audio from the telephony device 104 prior to transmission to the far-end station.

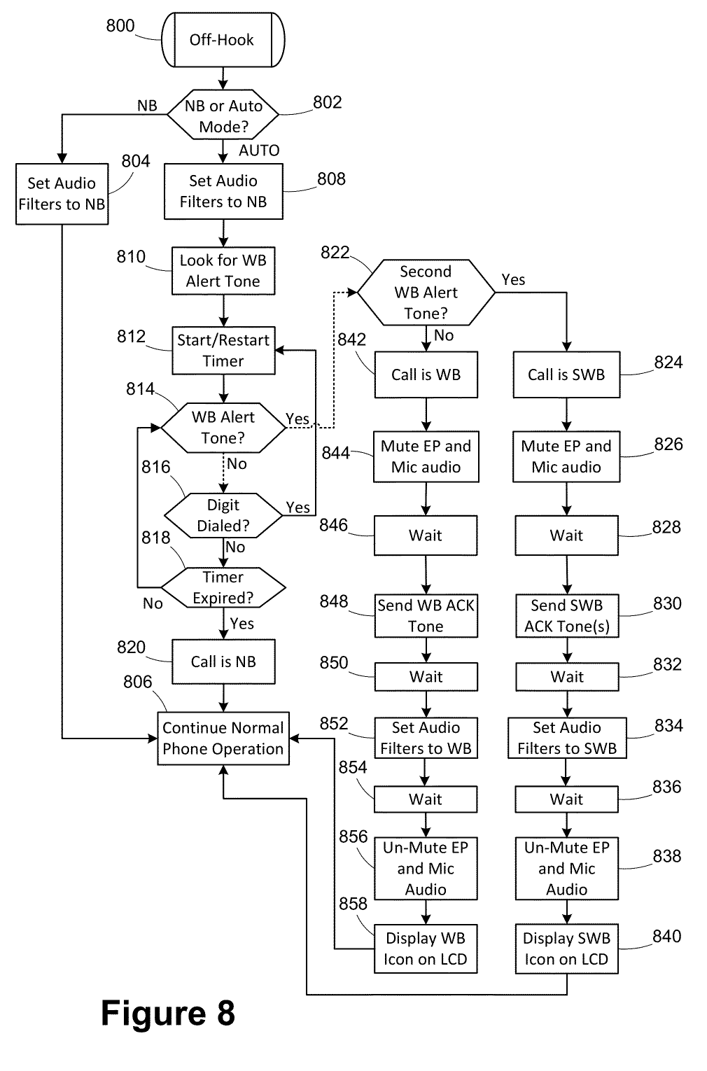

FIG. 8 is a flow diagram illustrating the operation of the telephony device 104 for communicating its audio bandwidth capability for an incoming or outgoing call sequence. In method block 800, the telephony device 104 goes off-hook due to an incoming call being answered or an outgoing call being placed. In method block 802, the telephony device 104 determines if it is set to NB mode or AUTO mode. If the telephony device 104 is set to NB mode in method block 802, the audio filters are set to NB in method block 804 (e.g., by selecting filters 434 and 450 in FIG. 4 or filters 534 and 550 in FIG. 5). Normal phone operation based on the configured filters is continued in method block 806. The telephony device 104 does not respond to any WBAT signals that may be provided on the line by the FXS port 141.

If the telephony device 104 is set to AUTO mode in method block 802, the audio filters are set to NB in method block 808. In method block 810, the telephony device 104 looks for a WB alert tone (WBAT) and starts a timer in method block 812. If no WBAT is received in method block 814 (e.g., using the tone detector 416 in FIG. 4), the telephony device 104 detects if a digit is dialed in method block 816. If a digit is dialed, the timer is reset in method block 812. If the timer expired without the detection of a WBAT in method block 818, the telephony device 104 designates the call as a NB call in method block 820 and normal phone operation is continued in method block 806.

The dashed lines exiting method block 814 indicate that the dialing timer is being run in parallel with WBAT detection. If a WBAT is received in method block 814 and the dialing timer has elapsed, the telephony device 104 looks for a second WBAT in method block 822. If a second WBAT is detected, it indicates that SWB Is supported, and the telephony device 104 designates the call as a SWB call in method block 824. The earpiece 438 and microphone 442 are muted in method block 826 to prevent the user from hearing the subsequent signaling tones. The telephony device 104 waits for a predetermined time period after receiving the WBAT in method block 828 and sends a SWB acknowledgment tone in method block 830. After waiting a predetermined time interval in method block 832, the telephony device 104 sets the audio filters to SWB in method block 834 (e.g., by selecting filters 430 and 446 in FIG. 4 or filters 530 and 546 in FIG. 5). After waiting a predetermined time interval in method block 836, the telephony device 104 un-mutes the earpiece 438 and microphone 442 in method block 838. A SWB icon may be provided on the LCD 426 in method block 840 to indicate the audio quality of the call. Normal phone operation based on the configured filters is continued in method block 806.

If a second WBAT is not detected in method block 822, it indicates that WB Is supported, and the telephony device 104 designates the call as a WB call in method block 842. The earpiece 438 and microphone 442 are muted in method block 844 to prevent the user from hearing the subsequent signaling tones. The telephony device 104 waits for a predetermined time period in method block 846 and sends a WB acknowledgment tone (ACK) in method block 848. After waiting a predetermined time interval in method block 850, the telephony device 104 sets the audio filters to WB in method block 852 (e.g., by selecting filters 432 and 448 in FIG. 4 or filters 532 and 548 in FIG. 5). After waiting a predetermined time interval in method block 854, the telephony device 104 un-mutes the earpiece 438 and microphone 442 in method block 856. A WB icon may be provided on the LCD 426 in method block 858 to indicate the audio quality of the call. Normal phone operation based on the configured filters is continued in method block 806.

Although FIGS. 6-8 include paths for both wideband and super-wideband, it is contemplated that only one enhanced bandwidth technique may be supported. For example, if the system only supports WB telephony, the SWB branches in the exemplary process flows may be eliminated.

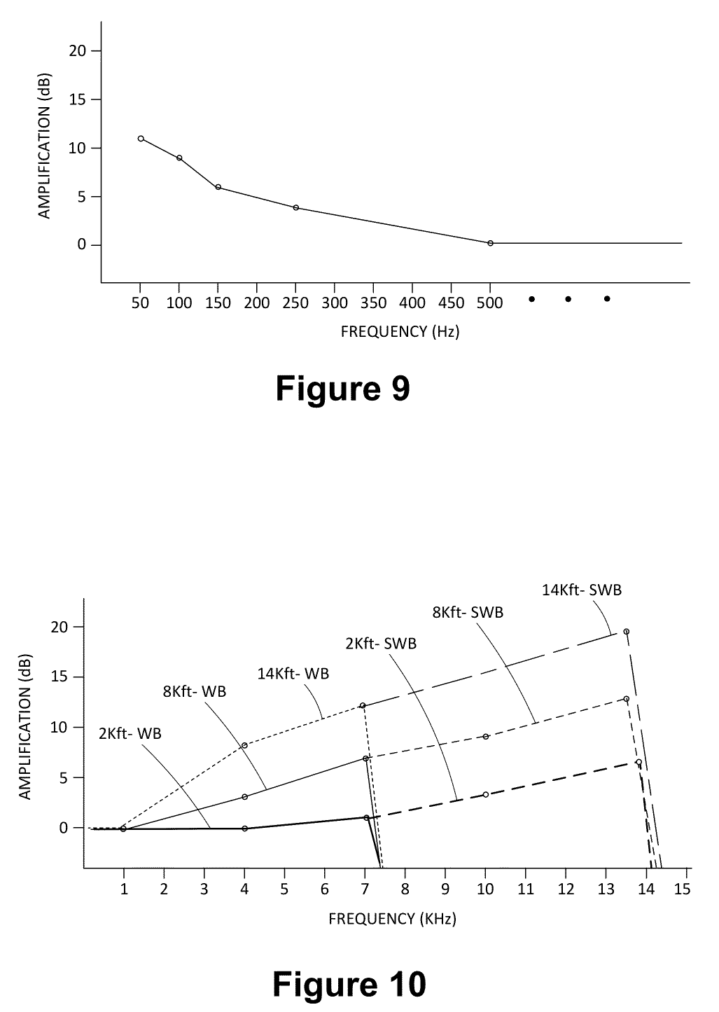

In some embodiments, the gateway 100 may also provide support for low frequency bass boost. FIG. 9 illustrates a bass boost equalization profile that may be applied to the far-end audio before it is sent by the gateway 100 to the telephony device 104. Bass boost enables small-sized speakers (e.g., the earpiece 438 or a speaker (not shown) in a speakerphone) to provide enhanced low frequency response, since their natural response is weak at these frequencies.

Higher frequency signals experience increased attenuation as the length of the subscriber line increases (i.e., defined by the distance between the gateway 100 and the telephony device 104. This attenuation is due to the fact that the telephone line behaves as an RC low-pass filter. To address this attenuation, a gateway 100 may use line equalization to increase the gain applied to higher frequencies. The line equalization may apply to both directions between the gateway 100 and the telephony device 104. FIG. 10 illustrates gain profiles that may be employed with wideband connections for different subscriber line lengths. Typical curves are shown for 26 AWG 2 Kft, 8 Kft, and 14 Kft telephone copper cable for wideband and super-wideband. As will be described below, the line equalization gains may be configured dynamically during the bandwidth negotiation exchanges. The equalization profiles of FIGS. 9 and 10 may be combined to provide bass boost and to recover attenuated higher frequency components. The high frequency line equalization profile may be applied to both transmit and receive signals, while the low frequency bass boost profile may be applied only to the audio transmitted by the gateway 100 to the telephony device 104.

The gateway 100 generates WB alert tones using one or more bursts of signaling tones that do not harmonically relate to telephony call signaling and are not common in human speech at this combination and exact duration. For example, the alert tone may be generated using the dual tones 5480 Hz+7080 Hz for a predetermined time period, such as 100 ms. Of course, other signaling techniques or frequencies may be employed, such as in-band or out-of-band tones, DC level variations or polarity reversals, AC signals, FSK signals, or a combination thereof. In the illustrated embodiment, the gateway 100 queries the telephony device 104 for WB capability using a single dual tone pulse of a predetermined duration and queries for SWB capability using two dual tone pulses of predetermined duration separated by a silent interval of a predetermined duration. Techniques for detecting the signaling pulses and silent intervals and measuring their durations are known to those of ordinary skill in the art, so they are not described in greater detail herein. For example, switched capacitor tone detectors and DSP-based implementations may be employed. An exemplary signaling technique for communicating the capabilities of the telephony device 104 to the gateway 100 is described below in Table 1.

TABLE 1
Alert Tones

| | Response to | Response to |
|---|---|---|
| | WB Alert | SWB Alert |
| | Tone | Tone |
| | (ACK Tones) | (ACK Tones) |
| Narrowband Telephone | None | None |
| Set or WB- or SWB- | | |
| Capable Telephone Set | | |
| Configured for NB | | |
| Operation | | |
| WB-Capable Telephone | DTMF A | DTMF A |
| Set without Line | | |
| Equalization Support | | |
| SWB-Capable Telephone | DTMF A | DTMF C |
| Set without Line | | |
| Equalization Support | | |
| WB Capable Telephone | DTMF B + 4000 Hz + | DTMF B + 4000 Hz + |
| Set with Line | 7400 Hz | 7400 Hz |
| Equalization Support | | |
| SWB-Capable Telephone | DTMF B + 4000 Hz + | DTMF D + 9000 Hz + |
| Set with Line | 7400 Hz | 13500 Hz |
| Equalization Support | | followed by |
| | | DTMF B + 4000 Hz + |
| | | 7400 Hz |

In general, DTMF tones are used in telephony for generating dialing tones. A DTMF pair includes a lower band component and an upper band component that are combined to generate a DTM pair. DTMF pairs are defined for each of the digit keys 0-9, the “*” key, and the “#” key. The DTMF industry standards also defines tones for “A”, “B”, “C”, and “D” digits that are not normally generated by keypads, but may be used for signaling. In the illustrated embodiment the telephony device 104 uses DTMF tones for communicating its audio bandwidth capability to the gateway 100. Other signaling methods may be employed, such as in-band or out-of-band tones, FSK, modem, white noise, DC signaling, or a combination thereof.

As shown in Table 1, a legacy telephony device 104 or a WB or SWB-capable telephony device 104 configured for “NB only” operation will not communicate any acknowledgement bandwidth tones (ACK) in response to the SWB or WB alert tones. Referring to FIG. 8, if only one WB alert tone is received in method block 822, signifying a WB call, the telephony device 104 (WB or SWB) responds with a DTMF A tone. If both alert tones are received in method block 822, signifying support for a SWB call, a WB telephony device 104 responds with a DTMF A tone to indicate that it can only support WB. A SWB telephony device 104 responds with a DTMF C tone, indicating that it can support WB or SWB.

For telephony devices 104 that also support line equalization, the signaling scheme uses different DTMF tones. In addition to the WB acknowledgement tones, test tones in higher frequency bands are also provided by the telephony device 104. Each of the four tones (i.e., the low and high components of the DTMF signal plus two test tones) are transmitted by the telephony device 104 at the same level. The gateway 100 may measure the attenuation in the test tones to measure the attenuation at each of the frequencies and estimate the attenuation curve at frequencies between 1 KHz and 7 KHz for WB and 1 KHz and 14 KHz for SWB. The FXS module 232 of the gateway 100 can then apply a corrective equalization to negate the estimated losses over that frequency range. The equalization results in a flatter transmission of the high frequency components and a more natural audio experience.

Table 1 also provides an exemplary signaling scheme for telephony devices 104 that support the optional line equalization. A WB-capable telephony device 104 responds to a single WBAT, signifying a WB call, with a DTMF B tone with the test tones at 4 KHz and 7.4 KHz superimposed thereon (i.e., with all tones transmitted at the same level). If both alert tones are received in method block 822, signifying support for a SWB call, a WB telephony device 104 responds with a DTMF B tone and the WB test tones at 4 KHz and 7.4 KHz superimposed thereon (i.e., with all tones transmitted at the same level) to indicate that it can only support WB. A SWB telephony device 104 responds with a DTMF D with test tones at 9 KHz and 13.5 KHz superimposed thereon, followed by a predetermined delay and then a burst of DTMF B with the test tones at 4 KHz and 7.4 KHz superimposed thereon. All the tones in both ACK bursts (e.g., 8 tones) are transmitted at the same level.

In one embodiment, after the telephony device 104 goes off-hook on an incoming or outgoing call, the gateway 100 analyzes the audio that is received from the telephony device 104, analog tone detectors or using digital signal processing techniques, to determine if there is a significant level of 50 Hz or 60 Hz hum that may be induced from AC sources to the telephone line. If such hum levels exceed a predetermined threshold, the gateway 100 applies coefficients for a notch filter to filter out the 50-60 Hz hum. If, after applying this notch filter, there is a significant level present from the first harmonic (i.e., 100-1120 Hz), then the gateway 100 may apply a second notch filter to filter out the harmonic. The hum filter or filters attempts to prevent AC hum from entering into the wideband or super-wideband audio stream. In another embodiment, the telephony device 104 may detect and filter AC hum on the signal received from the gateway 100 using one or more notch filters.

The use of the techniques described herein provides an enhanced user experience for adopters of wideband telephony. During early adoption phases for wideband telephony, most calls to far-end stations are not likely to be WB or SWB. The use of audio bandwidth expansion on the audio received from the far-end station provides for an improved user experience, even if the other user has not employed a wideband device. The use of bass boost improves the response of the earpiece speakers. The use of line equalization addresses high-frequency roll off on long loops. The detection and filtering of AC hum also improves the audio characteristics of the call. The use of signaling between the gateway 100 and the telephony device 104, as described herein allows the audio bandwidth capabilities of the telephony device 104 to be determined on a per call basis and allows negotiation with the far-end station regarding the CODEC used for the call. A user may employ different types of telephony devices 104 each with different bandwidth support, and the gateway 100 may dynamically adapt to the particular device selected on a per call basis. In an embodiment that uses tonal signaling, the negotiation technique described provides backwards compatibility with the vast number of legacy analog telephones and PSTN lines.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A gateway, comprising:
at least one network interface;
at least one analog telephony interface; and
a processing unit operable to receive a bandwidth signal over the at least one analog telephony interface from a telephony device and configure an audio bandwidth of a telephony connection for the telephony device over the at least one network interface based on the bandwidth signal.

2. The gateway of claim 1, wherein the at least one network interface is operable to communicate with an Internet protocol network, and the telephony connection comprises a voice over Internet protocol connection.

3. The gateway of claim 1, wherein the processing unit is operable to identify a first audio bandwidth of the telephony device based on the bandwidth signal and communicate the first audio bandwidth to a remote device over the at least one network interface.

4. The gateway of claim 3, wherein the processing unit is operable to receive a second audio bandwidth of the remote device and perform bandwidth expansion for an audio signal received from the remote device and provided to the telephony device responsive to determining that the first and second audio bandwidths indicate that the telephony device supports a higher bandwidth than the remote device.

5. The gateway of claim 1, wherein the processing unit is operable to communicate a bandwidth alert signal to the telephony device over the at least one analog telephony interface and detect the bandwidth signal from the telephony device after communicating the bandwidth alert signal.

6. The gateway of claim 1, wherein the processing unit is operable to communicate a bandwidth alert signal to the telephony device over the at least one analog telephony interface and set the audio bandwidth of the telephony connection to narrowband responsive to not detecting the bandwidth signal from the telephony device after communicating the bandwidth alert signal.

7. The gateway of claim 1, wherein the processing unit is operable to receive at least one line equalization test tone from the telephony device and configure a line equalization profile of the telephony connection based on the at least one line equalization test tone.

8. The gateway of claim 1, wherein the processing unit is operable to selectively apply a bass boost profile to a received audio signal based on the audio bandwidth of the telephony connection prior to communicating the received audio signal to the telephony device.

9. The gateway of claim 1, wherein the processing unit is operable to detect an AC hum on a signal received over the at least one analog telephony interface, and apply at least one notch filter to the received signal responsive to an amplitude of the AC hum being greater than a predetermined threshold.

10. A telephony device, comprising:
a speaker;
an interface for coupling to an analog telephone line;
a signal detector operable to receive a bandwidth alert signal over the interface;
a signal generator operable to send a bandwidth acknowledgement signal over the interface indicating a bandwidth capability of the telephony device; and
a processor operable to receive an analog voice signal over the interface having an audio bandwidth corresponding to the bandwidth capability and transmit the analog voice signal to the speaker.

11. The device of claim 10, wherein the telephony device comprises a base station coupled to the interface and a handset including the speaker, wherein the base station is operable to communicate the analog voice signal wirelessly to the handset.

12. The device of claim 10, wherein the bandwidth alert signal comprises a first dual-tone multi-frequency signal, and the bandwidth acknowledgement signal comprises a second dual-tone multi-frequency signal.

13. The device of claim 10, further comprising a processing unit interfacing with the signal detector and the signal generator and operable to determine based on the bandwidth alert signal that one of wideband support or super-wideband support is available, send a first bandwidth acknowledgement signal responsive to wideband support being available or a second bandwidth acknowledgement signal different than the a first bandwidth acknowledgement signal responsive to super-wideband support being available.

14. The device of claim 10, further comprising:
a plurality of audio filters, each having a different bandwidth;
a switch coupled to the speaker and the plurality of audio filters; and
a processing unit operable to control the switch to couple a selected one of the plurality of audio filters to the speaker.

15. The device of claim 10, further comprising:
a microphone;
a plurality of audio filters, each having a different bandwidth, coupled to the microphone;
a switch coupled to the plurality of audio filters; and
a processing unit operable to control the switch to select one of the plurality of audio filters coupled to the microphone.

16. The device of claim 10, further comprising:
a display device; and
a processing unit operable to interface with the signal detector and the signal generator to determine based on the bandwidth alert signal an audio bandwidth for the telephony device and control the display device to provide an indication of the audio bandwidth.

17. A method for interfacing with a telephony device, comprising:
receiving a bandwidth signal over an analog telephony interface from the telephony device; and
configuring an audio bandwidth of a telephony connection for the telephony device over the at least one network interface based on at least the bandwidth signal.

18. The method of claim 17, further comprising:
identifying a first audio bandwidth of the telephony device based on the bandwidth signal;
receiving a second audio bandwidth of a remote device;
performing bandwidth expansion for an audio signal from the remote device to generate an expanded audio signal responsive to determining that the first and second audio bandwidths indicate that the telephony device supports a higher bandwidth than the remote device; and
communicating the expanded audio signal to the telephony device.

19. The method of claim 18, further comprising:
communicating a bandwidth alert signal to the telephony device over the at least one analog telephony interface; and
detecting the bandwidth signal from the telephony device after communicating the bandwidth alert signal.

20. The method of claim 17, further comprising selectively applying a bass boost profile to a received audio signal based on the audio bandwidth of the telephony connection prior to communicating the received audio signal to the telephony device.

21. The method of claim 17, further comprising:
receiving at least one line equalization test tone from the telephony device; and
configuring a line equalization profile of the telephony connection based on the at least one line equalization test tone.
